(19) United States
(12) Patent Application Publication
(10) Pub. No.: US 2007/0292664 A1
(43) Pub. Date: Dec. 20, 2007

(54) Printed Support Substrate Method for Production Thereof and Use of Such a Support Substrate

(76) Inventor: Denny Wustner, Kaufbeuren (DE)

Correspondence Address: Daniel M Gurfinkel;Welsh & Katz, 120 S Riverside Plaza, 22nd Floor, Chicago, IL, 60606-3912, US

(21) Appl. No.: 11/659,403

(22) PCT Filed: Aug. 11, 2005
(86) PCT No.: PCT/EP05/08751

§ 371 Date: Mar. 29, 2007

(30) Foreign Application Priority Data
Aug. 17, 2004 (DE) 102004039871.2

(51) Int. Cl. B42D 15/00; B65D 75/30

(52) U.S. Cl. 428/195.1; 101/483

(57) ABSTRACT

Printed carrier substrate and method for the production thereof, wherein the carrier substrate is a transparent carrier film of plastics material, especially OPP or PET or the like, one side of which, and in particular the side which in use is the underside, is printed at least in part with a metallic ink, the metallic ink being based on nitrocellulose and containing metal particles in an average order of magnitude of ≦25 to 15 μm.

The invention relates to a printed carrier substrate, to a method of printing the carrier substrate and to use of a printed carrier substrate.

In recent years, the need for packaging material, and also labels, having metallic effects has increased. Paper or plastics sheets that are metallised over their entire area are usually used for the purpose. If unprinted window areas are desired, part of the printed sheet has to undergo demetallisation again, which is a relatively cost-intensive process. Also, when using printed sheets that have been metallised, for example with vapour-deposited aluminium, it is not possible, or possible only with much outlay, to produce the metallic effect in a thickness that differs from one area to another as a result of a greater or lesser density of metallisation.

Starting from the above-mentioned prior art, the present invention is based on the problem of making available a carrier substrate which, when a metallic ink is used, gives the optical impression of a metallised film but with considerably greater brilliance.

A problem of the present invention is furthermore to make available an appropriate method of producing such a printed film and also to specify a preferred use of such a printed film.

With respect to the carrier substrate, the problem is solved by the features of claim 1, with advantageous details and embodiments being described in claims 2 to 6.

With respect to the method, reference is made to claim 7.

Claim 8 sets out a preferred use of a carrier substrate printed in accordance with the invention.

In accordance with the invention, the carrier substrate is a transparent carrier film of plastics material, especially OPP (oriented polypropylene film) or PET (polyethylene film), one side of which, and in particular the side which in use is the underside, is printed (reverse printed) at least in part with a metallic ink, especially a silver ink, the metallic ink being based on nitrocellulose or like binders and containing metal particles in an average order of magnitude of ≧25 to 15 μm, especially ≧22 to 18 μm. Using this composition of metallic ink, especially silver ink, in reverse printing there is obtained through the film the optical impression of a metallised film having high brilliance.

A major advantage of the carrier film produced in accordance with the invention is that non-printed window areas or relatively weakly printed window areas can be produced without any problem. It is not necessary for the film to be partially demetallised for the purpose. Above all, the “reverse printing” in accordance with the invention allows raster printing of the metallic ink, so that a colour gradient from, for example, 100% area coverage (full tone) to areas of ≧5% becomes possible.

An especially advantageous, particularly optically advantageous, embodiment is obtained when the opposite or, that is to say, exposed side of the carrier film is printed with a highly glaze-forming ink (dyestuff ink or dispersed so as to be highly transparent), especially in the region of the reverse printing. By that means it is possible to achieve very specific colour effects corresponding to a metallised film. Especially by using a silver ink on the one side and printing the opposite side with a yellow translucent printing ink there is obtained a highly brilliant gold shade without onerous metallisation of the carrier film being required for the purpose.

The metallic ink preferably contains aluminium, bronze or silver particles, the type of metal of course influencing the colouration of the carrier film, this also especially being the case of course in dependence on the colour shade on the opposite or, that is to say, exposed side of the carrier film.

Of decisive importance for the optical brilliance is the size of particle or pigment in the metallic ink. The smaller the particles or pigments, the greater is the brilliance. Referring to the above-mentioned gold colouration, it may be mentioned that there are of course on the market a whole range of gold inks both for front-side printing and also for reverse printing. Those gold inks do not, however, achieve the brilliance that is possible using a carrier film printed in accordance with the invention.

In comparison with a metallised carrier film, it may also be mentioned that, in that case, a so-called “primer” is required in order to obtain sufficient ink adhesion. In the case of front-side printing of a reverse-printed film in accordance with the present invention, such a “primer” is not required.

With reference to the method in accordance with the invention, it may also be mentioned that the front-side printing on the side opposite the metallic ink, when required, is carried out subsequently to or simultaneously with the printing of the underside with metallic ink. Ultimately, this is dependent on the machinery set-up. Preferably, however, the front-side printing is not carried out until after the printing of the film with a metallic ink because the front-side printing can then be carried out as required in the individual case.

With reference to use of a carrier substrate according to the invention, it may be mentioned that it is suitable preferably as a packaging film for foodstuffs, pastes such as toothpaste, gels etc.

All features disclosed in the application documents are claimed as being important to the invention insofar as they are novel on their own or in combination compared with the prior art.

1-8. (canceled)

9. A printed carrier substrate comprising:
a transparent carrier film of material selected from the group consisting of plastics material, OPP, PET, and like plastics material, one side of which film, the side which in use is the underside, is printed at least in part with an ink selected from the group consisting of metallic ink, and a silver metallic ink, the said ink being based on nitrocellulose or like binders and containing metal pigments or metal particles in an average order of magnitude of 15 to ≦25 μm

10. A carrier substrate according to claim 9, wherein the said ink contains metal pigments or metal particles in an average order of magnitude of 18 to ≦22 μm.

11. A carrier substrate according to claim 9, further comprising areas which are unprinted or more weakly printed than full tone.

12. A carrier substrate according to claim 9, wherein the metallic ink contains pigments or particles selected from the group consisting of aluminum, bronze and silver.

13. A carrier substrate according to claim 9, wherein the opposite side, that is to say, the side which in use is the exposed side of the carrier film is printed with a translucent or glaze-forming ink.

14. A carrier substrate according to claim 13, wherein said translucent or glaze-forming ink is a yellow ink.

15. A carrier substrate according to claim 13, wherein an ink selected from the group consisting of a dyestuff ink, and a highly transparent disperse ink is used for the said translucent or glaze-forming ink.

16. A method of printing a carrier substrate, said method comprising the step of:
printing a transparent carrier film selected from the group consisting of plastics material, OPP plastics material, and PET plastics material, on one side, with an ink selected from the group consisting of a metallic ink, and a metallic silver ink, which is based on nitrocellulose and contains metal pigments or metal particles in an average order of magnitude selected from the group consisting of 15 to ≦25 μm, and 18 to ≦22 μm.

17. A method according to claim 16, wherein the said one side is the side which in use is the underside.

18. A method according to claim 17, further comprising the step of printing the opposite, that is to say, exposed side of the carrier film at a time selected from the group consisting of subsequently, and simultaneously with a translucent or glaze-forming ink.

19. Use of a printed carrier substrate in accordance with the invention as packaging film for foodstuffs, pastes, gels or like materials.
